(19) United States
(12) Patent Application Publication
(10) Pub. No.: US 2015/0129470 A1
(43) Pub. Date: May 14, 2015

(54) Side Seal Relief Valve

(71) Applicant: Mann+Hummel Purolator Filters LLC, Fayetteville, NC (US)

(72) Inventor: Timothy A. BYRD, West End, NC (US)

(73) Assignee: Mann+Hummel Purolator Filters LLC, Fayetteville, NC (US)

(21) Appl. No.: 14/079,267

(22) Filed: Nov. 13, 2013

(51) Int. Cl. B01D 35/147

(52) U.S. Cl. CPC B01D 35/1475
USPC 210/130

(57) ABSTRACT

A fluid filter includes a filtering medium and a relief valve. The relief valve includes an opening and is disposed between opposite longitudinal ends of the filtering medium. The filtering medium may include a plurality of pleats, and the relief valve may couple planar surfaces of two pleats. The opening of the relief valve may be directly connected to an outlet of the fluid filter, so that flow of fluid through the opening bypasses the filtering medium.

### BACKGROUND

Fluid filters play an important role in the operation of various fluid-based systems, where they remove harmful contaminants from fluid. These filters typically include an enclosure having a fluid inlet and a closed end, a filtering medium that is disposed within the enclosure, and a relief valve. The filtering medium is typically joined together with adhesives, or with metal clips. The relief valve provides an alternate route, so that fluid may still flow out of the fluid filter when the filtering medium becomes clogged. In existing fluid filters, the relief valve is disposed either immediately adjacent to the fluid inlet (up-front relief valve), or immediately adjacent to the closed end of the enclosure (dome-end relief valve).

These existing relief valves include multiple separate components, at least some of which are made of metal, and are therefore expensive to manufacture and require additional assembly. Accordingly, there is a need for a relief valve that is compatible with existing filtering media, reduces the number of parts, is less expensive to manufacture than the existing relief valves, and requires little to no additional assembly.

### SUMMARY

In one aspect of the present invention, a fluid filter includes a filtering medium and a relief valve that has an opening, and that is disposed between opposite longitudinal ends of the filtering medium.

In another aspect of the present invention, a relief valve for a filter includes a filtering medium. The relief valve has a body including at least one opening, and a movable portion that in a first configuration prevents a fluid from flowing through the at least one opening, and in a second configuration allows the fluid to flow through the at least one opening. The body has an elongated shape having a length that substantially corresponds to a length of the filtering medium along a longitudinal axis of the filtering medium.

In a further aspect of the present invention, a fluid filter includes a canister, a filtering medium, a base plate, and a relief valve. The canister has a closed end and a lateral wall. One side of the lateral wall is connected to the closed end, and another side of the lateral wall defines an open end of the canister. The filtering medium is disposed inside the canister, and the base plate is disposed on the open end of the canister. The relief valve is disposed on the filtering medium and is configured to allow fluid to flow through the relief valve after a pressure inside the fluid filter reaches at least a threshold level. The relief valve has an elongated body that is substantially parallel to the lateral wall.

Other objects, advantages, and novel features of the present invention will become apparent from the following detailed description of the invention when considered in conjunction with the accompanying drawings.

### BRIEF DESCRIPTION OF THE DRAWINGS

FIG. 1 shows the various regions of the filtering medium filter according to an exemplary embodiment of the invention;

FIG. 2 shows a fluid filter according to an exemplary embodiment of the invention;

FIG. 3 shows flow axes along different regions of the fluid filter according to the embodiment of FIG. 2;

FIG. 4 shows a top view of a fluid filter according to an exemplary embodiment of the invention;

FIGS. 5-5c show a relief valve according to an exemplary embodiment of the invention;

FIGS. 6 and 6a show a relief valve according to another exemplary embodiment of the invention;

FIG. 7 shows a cutaway view of a fluid filter according to an exemplary embodiment of the invention;

FIG. 8 shows an exploded view of fluid filter according to an alternate exemplary embodiment of the invention;

FIGS. 9-9c show a relief valve according to another exemplary embodiment of the invention;

FIGS. 10-10b show a canister according to an exemplary embodiment of the invention;

FIGS. 11-11b show a relief valve according to another exemplary embodiment of the invention.

### DETAILED DESCRIPTION OF EMBODIMENTS

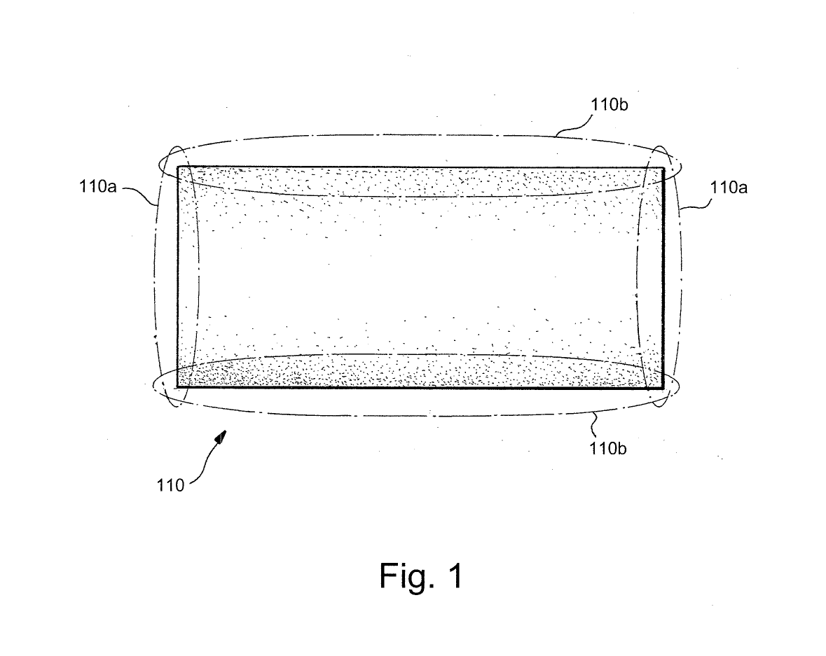

As shown in FIG. 1, filtering medium 110 may have a substantially elongated shape including longitudinal ends 110a and lateral ends 110b. The filtering medium 110, however, need not be limited to such shape and may in fact have any suitable shape as may occur to those of ordinary skill in the art, as long as the filtering medium 110 includes at least one surface upon which a relief valve (not shown) may be installed.

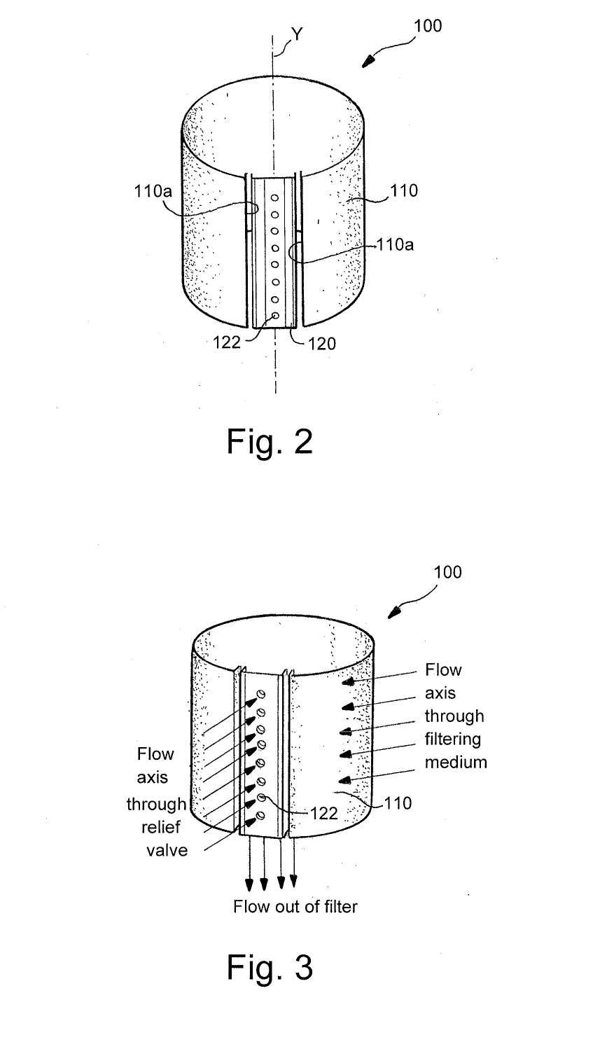

In one embodiment, such as the embodiment of FIG. 2, the filtering medium 110 may be formed into a fluid filter 100 having a substantially cylindrical shape. The filtering medium 110, however, need not be limited to such cylindrical shape, and in other embodiments may have a substantially cuboidal shape, or any other suitable shape as may occur to those of ordinary skill in the art, as long as the filtering medium 110 is able to separate unfiltered fluid from filtered fluid.

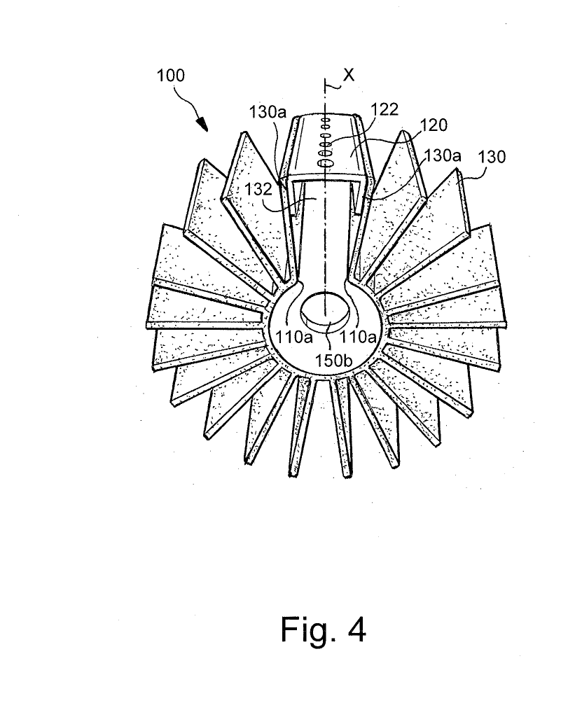

As shown in FIG. 2, the filtering medium 110 may be substantially flat along its length. Alternatively, as shown in FIG. 4, the filtering medium may include one or more pleats 130. As shown in FIG. 2, the relief valve (or bypass valve) 120 may be disposed between opposite longitudinal ends 110a of the filtering medium 110. Further, the relief valve 120 may couple opposite longitudinal ends 110a of the filtering medium 110. The relief valve 120 may include one or more openings 122. Further, the openings 122 may be arranged in a substantially linear fashion, or may be arranged in any other suitable manner throughout the relief valve 120, as long as the openings 122, regardless of their number or arrangement, allow passage of fluid therethrough when a pressure inside the fluid filter 100 reaches a given threshold level. The relief valve 120 remains closed when a pressure inside the fluid filter 100 is below a given threshold value, and the relief valve 120 opens when the pressure inside the fluid filter 100 reaches at least a given threshold value. Further, the relief valve 120 may extend substantially along the longitudinal direction “Y” of the fluid filter 100.

As shown in FIG. 3, when the relief valve 120 is open, flow axes of the fluid that flows through openings 122 may be substantially perpendicular to flow axes of the fluid exiting the fluid filter 100. The flow axes of the fluid through openings 122, however, need not be limited to such an arrangement, and may in fact make any angle to the flow axes of the fluid exiting the fluid filter 100, as long as the fluid is able to flow through openings 122, when the pressure inside the fluid filter 100 reaches at least a given threshold level. When the relief valve 120 is closed, the fluid within the fluid filter 100 flows through the filtering medium 110 before exiting the fluid filter 100. Thus, the flow direction of fluid flowing through filtering medium 110 is substantially parallel to the flow direction of fluid flowing through the openings 122 when the relief valve 120 is open.

As shown in FIG. 4, the filtering medium may include one or more pleats 130. Further, the relief valve 120 may be installed between at least two of the pleats 130. In some embodiments, the relief valve 120 may be installed between pleats 130 that are immediately adjacent to the longitudinal ends 110a of the filtering medium 110. As shown in FIG. 4, in this configuration each pleat 130 defines a planar surface 130a. In some embodiments, the relief valve 120 may couple planar surfaces 130a that are each immediately adjacent to a longitudinal end 110a of the filtering medium 110. As shown in FIG. 4, in this embodiment, the planar surfaces 130a define a passage 132 that directly connects the relief valve 120 to the outlet 150b of the fluid filter 100. That is, in this embodiment, when the relief valve 120 is open, at least some of the fluid that is radially exterior to (or on the pleated side of) the fluid filter 100 flows through the relief valve 120 and then through passage 132, without traveling through any surface of the filtering medium 110, directly to the outlet 150b of the filtering medium 110. In the embodiment of FIG. 4, a length of the relief valve 120 along the fluid flow axis X may be shorter than a length of the pleats 130 along the same direction. The relief valve 120, however, need not be limited to such configuration, and in other embodiments the relief valve 120 may have substantially the same length as the pleats 130 along the fluid flow axes, or the relief valve 120 may be longer than the pleats 130 along the fluid flow axes.

Although in the embodiments of FIGS. 1-4 the relief valve 120 is depicted as extending in substantially the same direction as the longitudinal direction Y of the fluid filter 110, the relief valve 120 need not be limited to such configuration. For instance, in other embodiments, the relief valve 120 may be disposed on the filtering medium 110 such that the relief valve 120 is substantially parallel to the lateral ends 110b of the filtering medium 110. That is, in other embodiments the relief valve 120 may extend in a direction that is substantially perpendicular to the longitudinal direction Y of the fluid filter 110. Alternatively, the relief valve 120 may be disposed on the filtering medium 110 at any desired angle to the longitudinal direction Y of the fluid filter 110, as may occur to those of ordinary skill in the art.

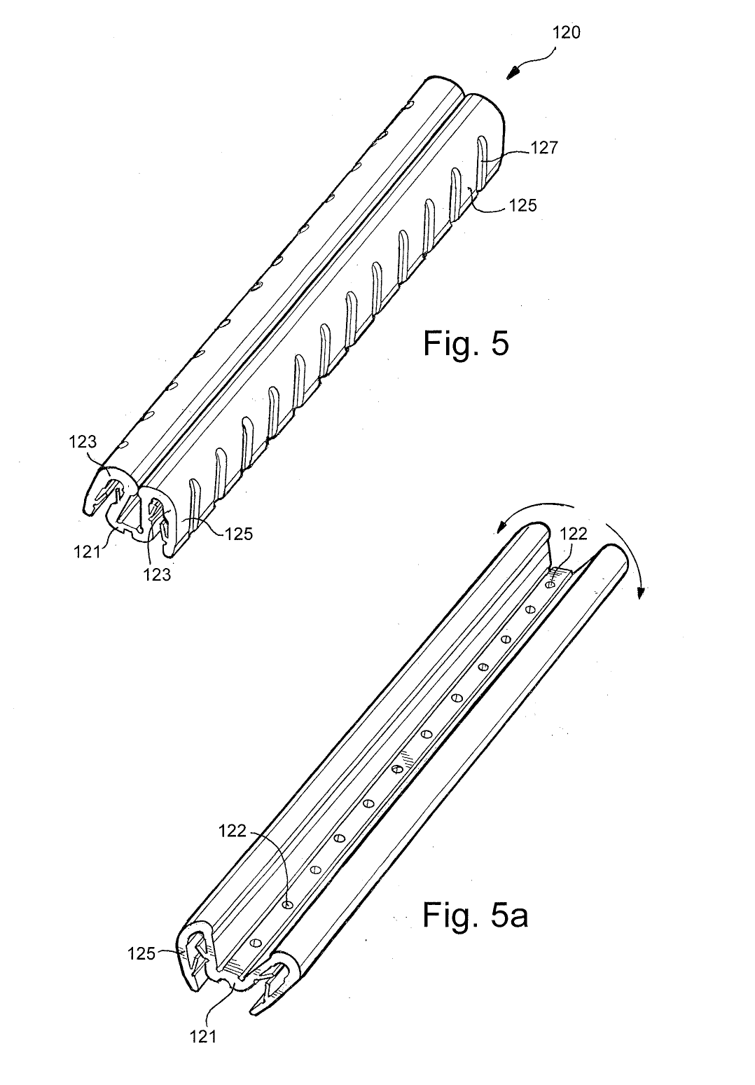

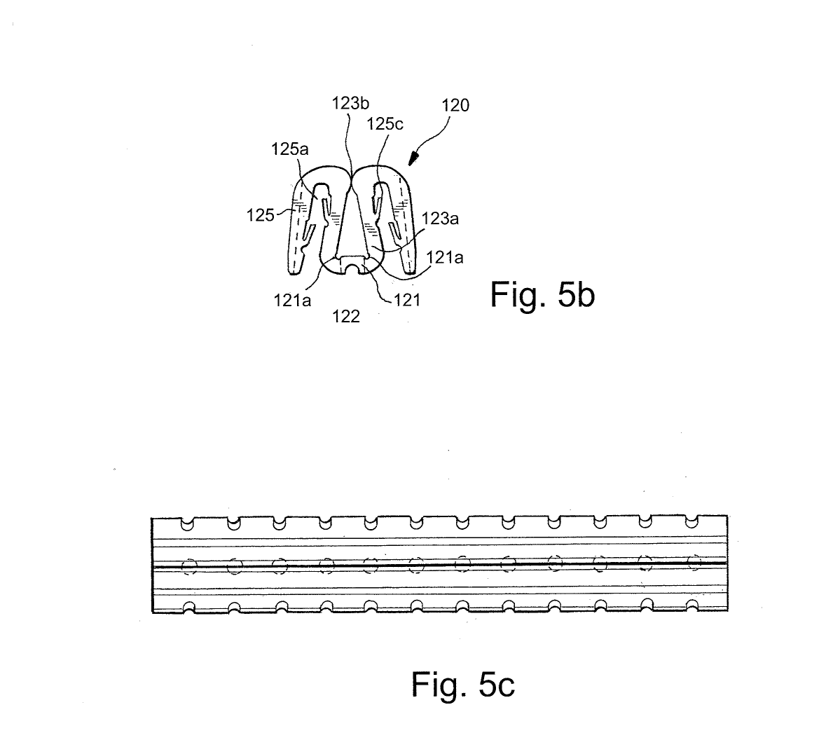

As shown in FIG. 5, the relief valve 120 includes a body 121 that has a substantially elongated shape. The length of the body 121 may range from about 0.5 inch to about 2.50 inches, and in some embodiments, the length of the body 121 may be substantially the same as the length of the longitudinal ends 110a of the filtering medium 110, or substantially the same as the length of the pleats 130 (i.e., the length of the pleats along the longitudinal direction Y of the fluid filter 100). The body 121, however, need not be limited to such range of lengths, and may in fact have any suitable length.

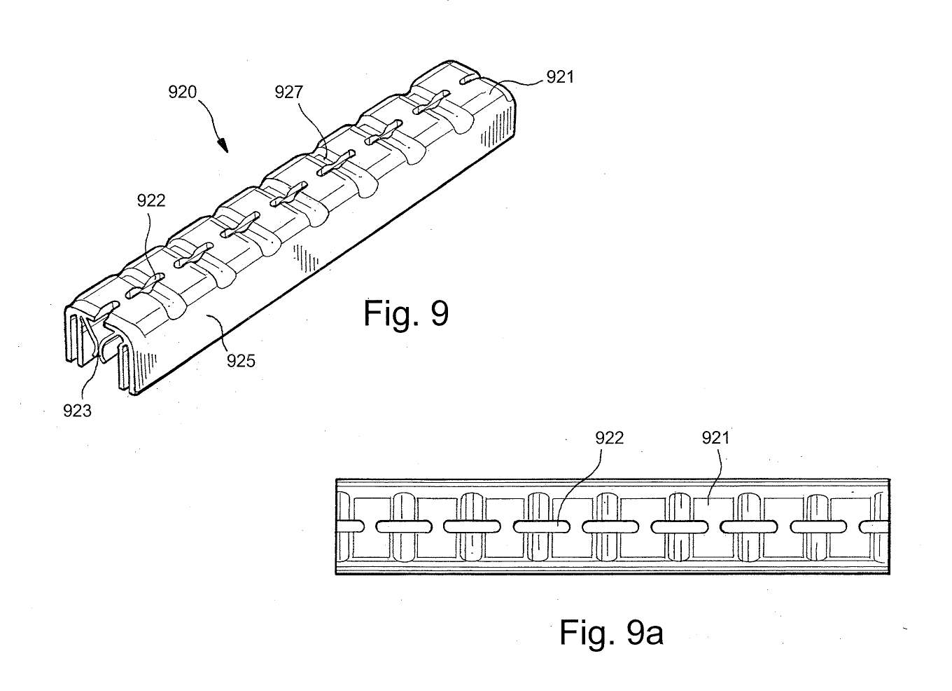

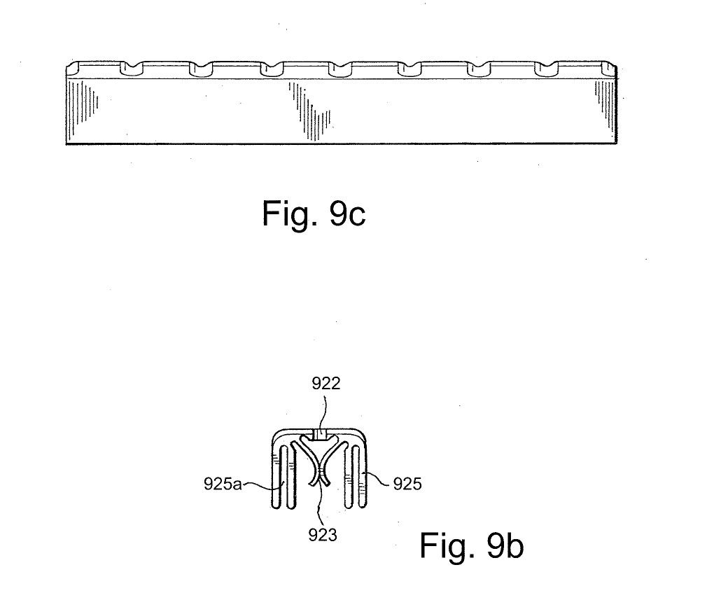

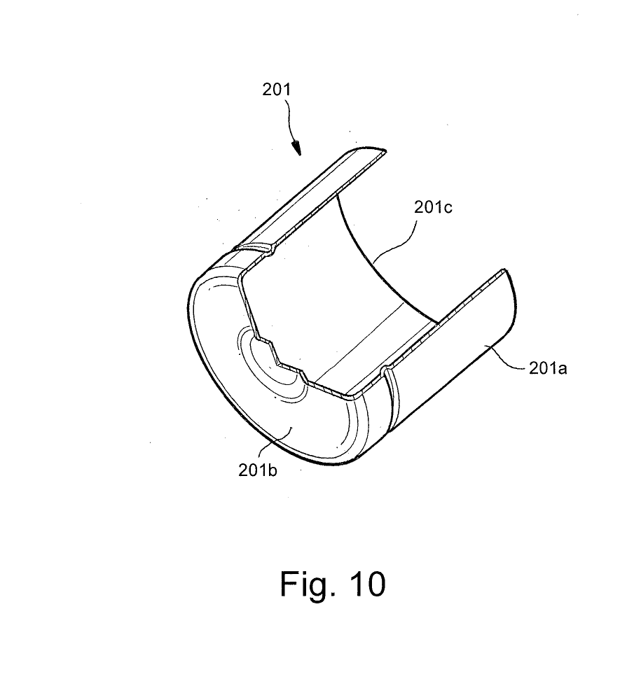

As shown in FIGS. 5a and 5c, the body 121 may include one or more openings 122. In some embodiments, the openings 122 may have a substantially round shape. Alternatively, as shown in FIGS. 9 and 9a, the openings 922 may have a substantially rectangular shape, or any other suitable shape as may occur to those of ordinary skill in the art, as long as the openings 122, 922 allow fluid within the fluid filter 100 to pass therethrough. Further, as shown in FIGS. 5a and 5c, the openings 122 may be arranged in a row substantially along the middle of the body 121. Alternatively, the openings 122 may be arranged in two or more rows that are substantially parallel to one another, or may be placed in any other suitable arrangement along the valve body 121. Further, the length of each row may be substantially coextensive with the valve body 121, or may have a different length than the valve body 121.

As shown in FIG. 5, the relief valve 120 may include one or more movable portions 123 that extend from the valve body 121. As shown in FIG. 5, in a first configuration, the relief valve 120 is closed and the movable portions 123 prevent fluid from flowing through the openings 122 by abutting along the length of the body 121, thereby forming a sealing region 123b that prevents fluid from reaching openings 122. In a second configuration, such as the embodiment of FIG. 5a, the movable portions 123 move in a direction away from one another and this separation allows fluid to reach and pass through openings 122. As shown in FIGS. 5 and 5a, when the relief valve 120 is open, all of the openings 122 are exposed, and when the relief valve 120 is closed, none of the openings 122 are exposed. The relief valve 120, however, need not be limited to such configuration, and in other embodiments only certain regions of the relief valve 120 may open and close.

For instance, in alternate embodiments, when an internal pressure inside the fluid filter 100 reaches a threshold level, only a given portion of relief valve 120, for example, a section of the relief valve 120 near the middle of the valve body 121 along a longitudinal direction thereof may open. In this embodiment, as the pressure inside the fluid filter 100 increases, additional regions of the relief valve 120 may open, until the pressure inside the fluid filter 100 reaches a level that causes the relief valve 120 to be fully open, as shown in FIG. 5a. The region of the relief valve 120 that first opens need not be limited to a center portion thereof. In fact, in other embodiments, the region of the relief valve 120 that is closest to the fluid inlet, or the region of the relief valve that is farthest from the fluid inlet may open first. Further, in other embodiments, two or more regions of the relief valve 120 may open substantially at the same time, in response to the same internal pressure in the fluid filter 100.

The force that acts on the relief valve 120 to cause the relief valve 120 to open is applied by the fluid within fluid filter 100. As the filtering medium 110 begins to accumulate an increasing number of impurities, the flow of fluid through the filtering medium 110 decreases, the flow of fluid into the fluid filter 100, however, remains relatively constant. This reduction of flow out of the fluid filter 100, combined with the relatively constant flow of fluid into the fluid filter 100 effectively increases the pressure within fluid filter 100. The relief valve 120 according to the embodiments of the present invention is configured to open when the pressure of the fluid within fluid filter 100 reaches at least a given threshold value.

In some embodiments, a threshold pressure of 30 pounds per square inch (PSI) or more that is applied to the relief valve 120 will cause the relief valve 120 to open. In other embodiments, the threshold pressure that opens the relief valve 120 may range between 25 PSI to about 30 PSI. In yet other embodiments, the threshold pressure that opens the relief valve 120 may range from 1 PSI to 5 PSI, 5 PSI to 10 PSI, from 10 PSI to 15 PSI, from 15 PSI to 20 PSI, or from 20 PSI to 25 PSI. In fact, the threshold pressure that opens the relief valve 120 may have any suitable value, or range of values that may occur to one of ordinary skill in the art, as long as the relief valve 120 is structurally configured to open in response to the application of a given pressure, and the given pressure is lower than a pressure necessary to rupture the enclosure or canister within which the filtering medium 110 and the relief valve 120 are enclosed.

The force that tends to close, or oppose opening of the relief valve 120 once the pressure inside the fluid filter 100 is below the threshold pressure may arise from the elastic properties of the movable portion 123. For instance, in some embodiments, the relief valve 120 may be extruded out of a plastic, such as, for example, a Nylon, like RILSAN®. The material used to manufacture the relief valve 120, however, need not be limited to a plastic, and may in fact be any material having elastic properties that allow the movable portion 123 to reassume, or maintain a closed position, when the pressure inside fluid filter 100 is below a threshold level, and may various metals and metal variants.

Further, the structural arrangement of the relief valve 120 may also contribute to the force that tends to close, or oppose opening of the relief valve 120. For example, as shown in FIG. 5b, the relief valve 120 may be extruded such that the movable portions 123 extend from the valve body 121 at different directions, such that the movable portions 123 contact each other, thereby creating a sealing region 123b. In other embodiments, the thickness of the relief valve 120 may also contribute to the opening and closing properties of the relief valve 120. For instance, in some embodiments, a center region of the relief valve 120 may be thinner than the rest of the relief valve 120. Such thinner regions may exert a lower resistive force against the inner pressure in fluid filter 100, and therefore the thinner regions of the relief valve 120 may open before other, thicker regions of the relief valve 120.

The valve body 121 may also contribute to the opening and closing of the relief valve 120. For instance, in some embodiments, such as the embodiment shown in FIG. 5b, one or more flex points 121a may be disposed on the valve body 121, and these flex points 121a may also contribute to the opening and closing of the relief valve 120. As shown in FIG. 5b, the flex points 121a may be positioned at a junction between the valve body 121 and a lower end 123a of the movable portion 123. In this embodiment, the valve body 121 extends along one plane, and the movable portion 123 may extend from the valve body 121 along a different plane. That is, the movable portion 123 may, for example, extend along a direction that is substantially perpendicular to the valve body 121. In other embodiments, however, the movable portion 123 may extend in any other desired direction with respect to the valve body 121, as long as the valve body 121 and a lower portion of the movable portion 123a meet a junction. The relief valve 120 may include two movable portions 123, and in this configuration, the flex points 121a may be disposed at both junctions between each movable portion 123 and valve body 121.

The flex points 121a may be formed by removing material from the junction between the lower end 123a of the movable portion 123 and the valve body 121, or by extruding around the junction region, so as to create a small void between the valve body 121 and the lower end 123a of the movable portion 123. In some embodiments, such as the embodiment of FIG. 5b, the flex points 121a may have a substantially semicircular shape. Further, the flex points 121a may be formed along the entire length of the valve body 121, so as to define a channel that is coextensive with the length of the valve body 121. The relief valve 120, however, need not be limited to such configuration. In fact, in other embodiments, the flex points 121a may have any suitable shape, or may be positioned along a part, or parts of the length of the valve body 121. Further, the flex points 121a may be positioned in a continuous, alternating, or any other suitable fashion along the length of the valve body 121. For example, in alternate embodiments, the flex points 121a may be disposed only near a midpoint along the length of the valve body 121. Alternatively, the flex points 121a may be disposed on a plurality of regions along the length of the valve body 121, and each of the plurality of regions may be separated by substantially the same distance, or by a different distances.

As shown in FIG. 5b, an upper end of the movable portion 123 defines a sealing region 123b, such that when the relief valve 120 is in the closed position, the movable portions 123 abut along the length of the valve body 121 at sealing region 123b. The sealing region 123b may have any desired shape. For instance, as shown in FIG. 5b, the sealing region 123b may have a semicircular shape. The sealing region 123b, however, need not be limited to such configuration, and in other embodiments may have any suitable shape, as may occur to those of ordinary skill in the art. Further, each sealing region 123b may have substantially the same shape or a different shape. When the sealing regions 123b have different shapes, the different shapes may be complementary to one another. For instance, one sealing region 123b may have a concave shape, while the other sealing region 123b may have a convex shape. Alternatively, the sealing regions 123b may have different shapes that are not complimentary, and may in fact have any suitable shape as may occur to those of ordinary skill in the art, as along as the sealing regions 123b are able to come into contact to prevent a fluid from flowing therethrough.

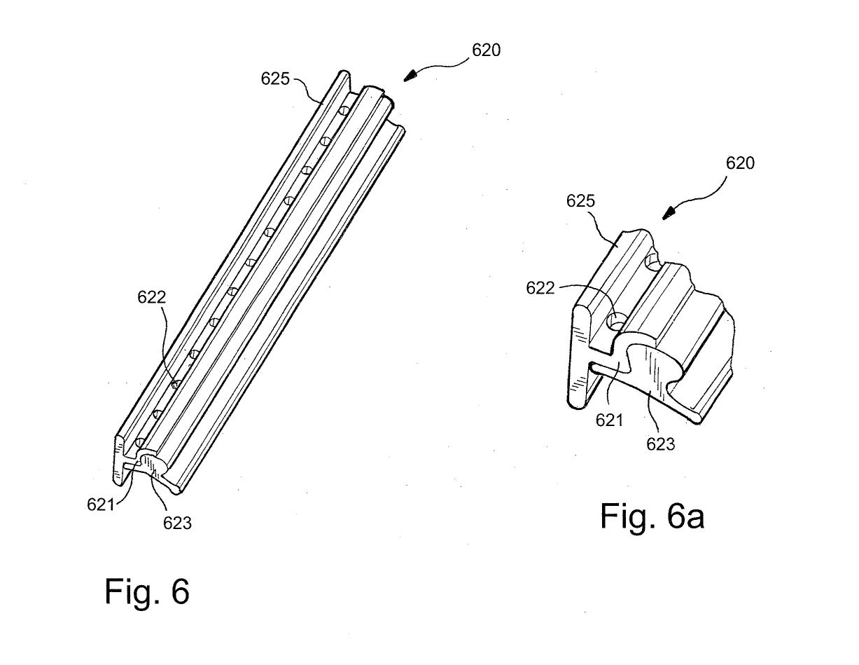

As shown in FIG. 6, the movable portion 623 may be in direct contact with the openings 622. In this embodiment, the movable portion 623 may be formed by a region of the valve body 621 that may have different elastic properties than the remainder of the valve body 621. Alternatively, the movable portion 623 may be formed of a different material. The different material may, for example, be a synthetic material such as any organic polymer plastic, a rubber, or any other suitable material. Further, the thickness and kind of material selected for the movable portion 623 may vary, depending on the required opening threshold pressure of the relief valve 620.

As shown in FIG. 6a, the movable portion 623 is in direct contact with the opening 622 forming a seal thereon, so that when the relief valve 620 is closed, the movable portion 623 prevents fluid from passing through openings 622. In this embodiment, the movable portion 623 is configured in such a way that when the pressure inside the fluid filter (not shown) reaches at least a threshold pressure, the pressure exerted on the movable portion 623 becomes greater than the resistive force exerted by the movable portion 623 against openings 622, and the movable portion 623 moves away from openings 622, thereby allowing fluid within fluid filter (not shown) to flow through openings 622.

The relief valve, however, need not be limited to such configuration. For instance, as shown in FIG. 5b, a space may separate movable portion 123 from openings 122. Moreover, the space that separates the movable portion 123 from openings 122 may be radially exterior to the openings 122 (i.e., directly above the opening 122). Alternatively, in other embodiments, such as those depicted in FIGS. 9 and 9b, the space between movable portion 923 and openings 922 may be radially interior to the opening 922 (i.e., directly below openings 922). Alternatively, as shown in FIG. 6, other embodiments may be substantially devoid of any space between the movable portion 623 and openings 622. Further, as shown in FIG. 9, the valve body 921 may be the most radially exterior portion of the relief valve 920. That is, the valve body 921 may be closer to the enclosure or canister (not shown) into which the relief valve 920 is inserted. The valve body 921 may include flow channels 927 and openings 922, and these flow channels 927 may extend transversally with respect to the length of the valve body 921. The relief valve 920 may further include attachment portions 925, which define at least one attachment cavity 925a. The relief valve, however, need not be limited to such configuration and in other embodiments, such as the embodiment of FIG. 5-5b, the valve body 121 may be radially interior relative to, for example, sealing region 123b, and may also be devoid of any flow channels 127.

The relief valve may also include one or more attachment portions. As shown in FIG. 5b, the attachment portions 125 may define an attachment cavity 125a, into which the filtering medium 110 may be inserted. When the filtering medium 110 includes one or more pleats 130, the attachment cavity 125a may have a shape that is substantially complementary to the pleats 130. In this embodiment, at least two surfaces and an edge of one or more pleats 130 may be inserted into each attachment cavity 125a. In some embodiments a single pleat 130 may be inserted into each attachment cavity 125a. Alternatively, two or more pleats 130 may be inserted into each attachment cavity 125a. Further, as shown in FIG. 5b, the attachment cavity 125a may include means for securing the attachment portion 125 to the filtering medium 110. In some embodiments, these means for securing the attachment portion 125 to the filtering medium 110 may include projections 125c. Alternatively, adhesives, areas within the attachment cavity 125a having different coefficients of friction, areas within the attachment cavity 125a having different thicknesses, fasteners that span through at least part of the attachment portion 125 and the filtering medium 110, hook-and-loop interaction between the attachment cavity 125a and the filtering medium 110, or any other suitable means, may be used as the means for securing the attachment portion 125 to the filtering medium 110.

The width of the attachment cavity 125a may vary. In some embodiments the width of the attachment cavity 125a may range from about 0.025 inch to about 0.045 inch. The width of the attachment cavity 125a, however, need not be limited to such configuration and may in fact have any width that is slightly less than the thickness of a pleat a 130, substantially the same as the thickness of a pleat 130, or even slightly larger than the thickness of a pleat 130. Further, the distance between each attachment portion 125 may vary. For instance, in some embodiments the distance between each attachment portion 125 may range from about 0.30 inch to about 0.40 inch. The distance between the attachments portions 125, however, need not be limited to such range, and may in fact have any suitable value.

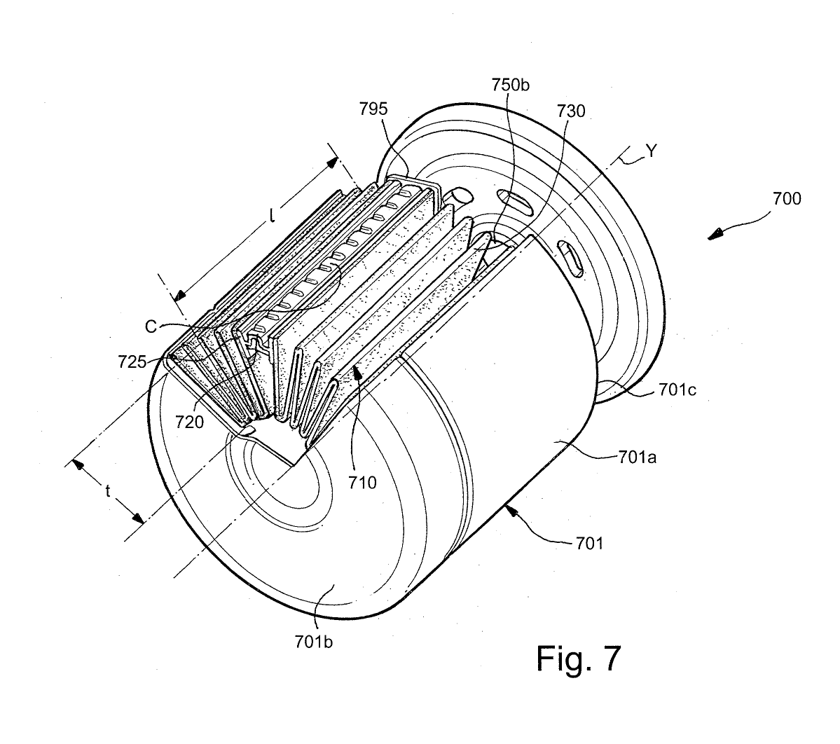

The length of the attachment portions with the regard to the transversal direction of the pleats may vary. For instance, as shown in FIG. 7, the length of the attachment portion 725 may be substantially smaller than a transversal length “t” of the pleats 730. In such embodiments, the length of the attachment portion 725 may range from about 0.25 inch to about 0.35 inch. The length of the of attachment portion 725, however, need not be limited to such configuration, and in other embodiments may have a length that is substantially the same as the transversal length “t” of the pleats 730, or may even be slightly larger than the transversal length “t” of the pleats 730. In fact, the attachment portions 725 of relief valve 720 may have any suitable length, as long as the relief valve 720 is installed on the pleats 730 in such a way that a center of mass “C” of the relief valve 720 is closer to a lateral wall 701a of canister 701, than to closed end 701b, and closer to lateral wall 701a than to open end 701c.

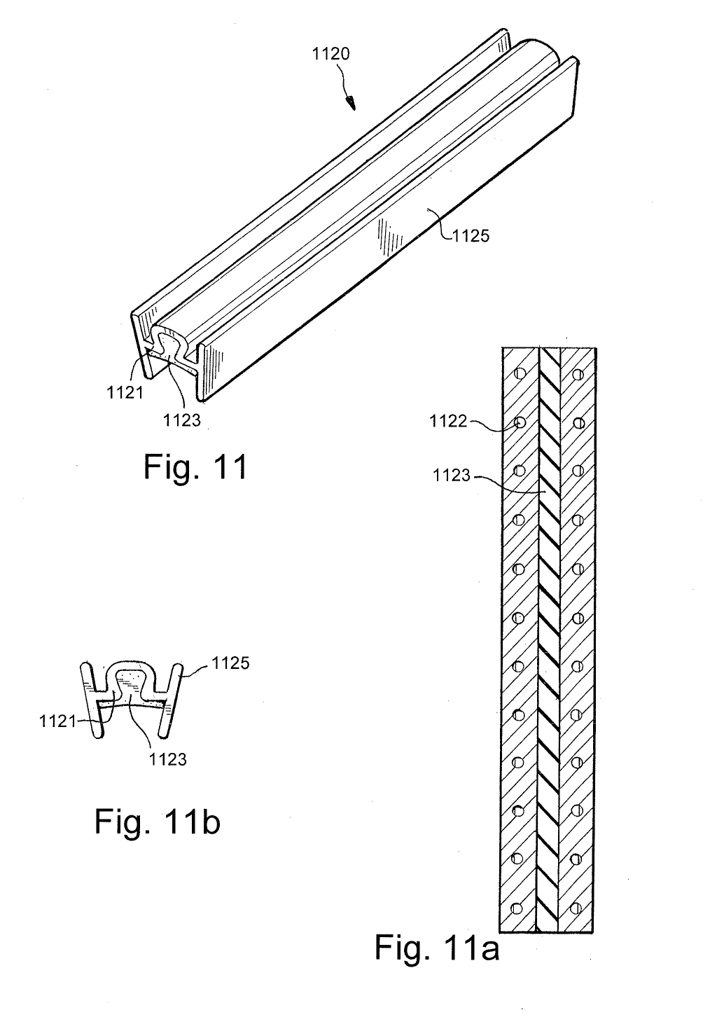

As shown in FIGS. 6 and 11, the attachment portion may be devoid of any attachment cavities. Thus, the attachment portion 625, 1125 may be substantially flat and may be attached to the filtering medium (not shown) with an adhesive, or any type of fastener as may occur to those of ordinary skill in the art. Further, in some embodiments, such as those shown in FIGS. 5-5c and 9-9c, the valve body 121, 921 the movable portion 123,923 and the attachment portions 125, 925 may be integrally formed. That is, the valve body 121, 921 the movable portion 123, 923 and the attachment portions 125, 925 may be extruded together in a single manufacturing step, as a single unitary structure that requires no further assembly. Alternatively, as shown in FIGS. 6 and 11, the relief valve 620, 1120 may be made of two or more different materials, where for example the valve body 621, 1121 (and openings 622, 1122), the attachment portions 625, 1125 are made of one material, and the movable portion 623, 1123 is made of another material.

As shown in FIGS. 5 and 5b, the relief valve 120 may have a cross-sectional shape that is substantially shaped like the letter “m.” As shown in FIGS. 11-11b, other embodiments may have a cross-sectional shape that is substantially shaped like the letter “h.” As shown in FIGS. 9 and 9b, however, the relief valve 920 need not be limited to such configuration, and may in fact have any desired cross-sectional profile as may occur to those of ordinary skill in the art.

The relief valve may also include one or more flow channels. As shown in FIG. 9, flow channels 927 may be formed on valve body 921. Alternatively, as shown in FIG. 5, the flow channels 127 may be formed on the attachment portions 125. The flow channels 927, 127 are configured to direct a flow of fluid away from the relief valve 920, 120 and toward the filtering medium (not shown), so that when the relief valve 920, 120 is closed, the impact that the relief valve 920, 120 has on flow of fluid within the filter is minimized. The flow channels 927, 127 may be equidistant from one another, or randomly spaced apart. Further, the flow channels 927, 127 may have any desired shape, as may occur to those of ordinary skill in the art, as long as the flow channels 927, 127 direct fluid toward the filtering medium.

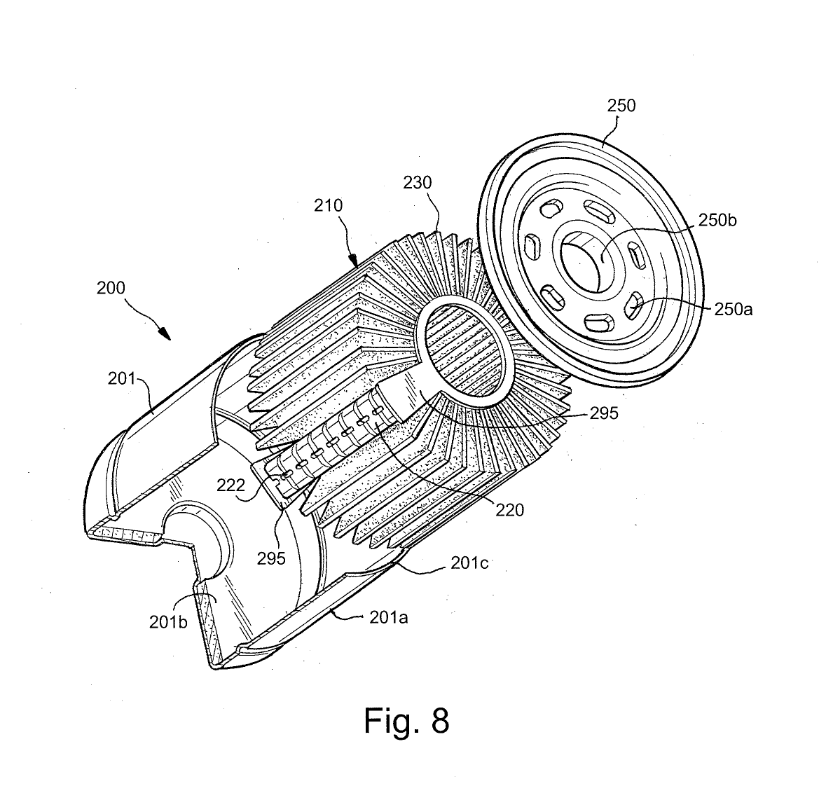

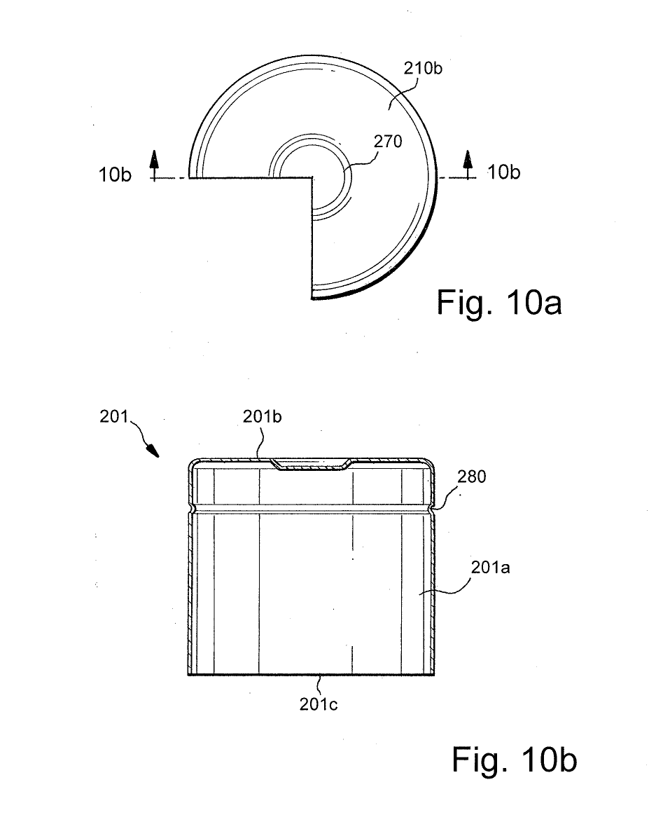

Referring to FIGS. 7 and 8, the fluid filter 200 may include a canister 201. The canister 201 may include a closed end 201b and a lateral wall 201a that is connected to the closed end 201b and that defines an open end 201c. As shown in FIGS. 7 and 10, the canister 201 may have a substantially cylindrical shape with a first end being closed (closed end 201b) and the other end being open (open end 201c). The canister 201, however, need not be limited to such cylindrical configuration, and may in fact have any suitable shape as may occur to those of ordinary skill in the art, as long as the canister 201 has a lateral wall 201a and at least one closed end 201b. Further, the canister 201 need not have a continuous or consistent shape throughout the canister 201. For instance, in some embodiments, at least one or more regions on the lateral wall 201a may be flat, or have any suitable shape that facilitates the application of a torque onto the canister 201. Further, as shown in FIG. 10a, the closed end 201b of canister 201 may include an indentation region 270. Alternatively, the closed end 201b may be substantially flat, dome-shaped, or may include a square or any other suitable shaped protrusion that facilitates the application of a torque onto the closed end 201b of the canister 201.

The dimensions of the canister 201 may vary. For instance, in some embodiments the diameter of the opening 201c may range between about 3.5 inches to about 2.5 inches, and the length of the lateral wall 201a, along a longitudinal direction of the canister 201 may vary between about 3.5 inches to about 2.5 inches. The dimensions of the canister 201, however, need not be limited to such ranges, and may in fact have any suitable dimensions, as long as the canister 201 is capable of accommodating therein the filtering medium 210 and the relief valve 220. Further, as shown in FIG. 10b, the canister 201 may include at least one bead 280 that extends around the lateral wall 201a. The bead 280 may be formed, for example, by an indentation on the canister 201 having a depth ranging from about 0.04 inch to about 0.08 inch. The bead 280, however, need not be limited to such configuration and may in fact have any suitable depth, and may be placed anywhere along the lateral wall 201a, as long as the bead 280 extends from the canister 201 toward filtering medium 210, to contact the filtering medium 210 and thereby prevent motion of the filtering medium 210 relative to the canister 201.

As shown in FIG. 10, the canister 201 defines a volume of space therein, in which the filtering medium 210 may be disposed. The filtering medium 210 may include one or more pleats 230. As shown in FIG. 8, on the open end 201c of canister 201, there may be disposed a base plate 250 that has a shape that is complementary to the open end 201c. The base plate 250 may include one or more fluid inlets 250a and at least one fluid outlet 250b. In one embodiment, the fluid inlets 250a may be disposed around the fluid outlet 250b. The base plate 250, however, need not be limited to such configuration. In fact, in other embodiments, the fluid inlets 250a and the outlet 250a may have any suitable configuration, as may occur to those of ordinary skill in the art, as long as at least one fluid inlet 250a is placed somewhere on the base plate 250 to bring fluid into the fluid filter 200, and at least one fluid outlet 250b is placed somewhere on the base plate 250 to carry fluid out of the fluid filter 200.

The fluid filter 200 may further include a relief valve 220, also known to those of ordinary skill in the art as a bypass valve. As shown in FIG. 8, the relief valve 220 may have a substantially elongated shape with one or more openings 222, and may be disposed on the filtering medium 210. As shown in FIG. 7, the longitudinal length “l” of the relief valve 720, or the length of the relief valve 720 along the longitudinal direction Y of the filter 700, may be substantially the same as the length of the pleats 730 along the same direction. As shown in FIG. 7, the longitudinal direction “Y” of the fluid filter 700 is the direction from the closed end 701b of the canister 701 to the open end 701c of the canister 701, or a direction that is substantially parallel to the lateral wall 701a of the canister 701.

Further, the relief valve may couple two or more pleats 730 together. When a pressure inside the fluid filter 700 reaches at least a threshold value, the relief valve 2720 is configured to open and thereby allow a fluid within the fluid filter 700 to pass through the relief valve 720 and then to the fluid outlet 750b, without having to pass through the filtering medium 710. That is, the relief valve 720 allows the fluid within filter 700 to flow between at least two pleats 730, but without having to flow through any pleats 730 to reach the fluid outlet 750b. On the other hand, when the pressure within the fluid filter 700 is below a given threshold, the relief valve 720 is configured to remain in a closed position, such that the fluid within fluid filter 700 passes through the filtering medium 710, rather than through the relief valve 720.

The relief valve 720, however, need not be limited to having a substantially longitudinal shape. For instance, in other embodiments the relief valve 720 may be configured such that all sides of the valve have substantially the same length. In such embodiment, the relief valve 720 may have a substantially shorter length than a length of the pleats 730 along the longitudinal direction “Y” of the fluid filter 700. Accordingly, in this embodiment, the relief valve 720 may couple together only part of two pleats 730, so that the areas of the pleats 730 that are not coupled by the relief valve 720 are coupled together by other means, such as metal clips, or adhesives, or any of the other suitable means. Thus, the relief valve 720 may have any suitable shape, as long as the relief valve 720 is placed somewhere on the filtering medium 710, and as long as, irrespective of its position and irrespective of its shape, a the center of mass “C” of the relief valve 720 is closer to the lateral wall 701a of the canister 701 than to the closed end 701b, or closer to the lateral wall 701a of the canister 701 than to the open end 701c.

The configuration of the longitudinal ends of the relief valve may vary. For instance, as shown in FIGS. 5 and 9, the longitudinal ends of the relief valve 120 may be open. As shown in FIG. 8, in such configuration, when the relief valve 220 is installed in the filtering medium 210, a seal 295 may be applied to the longitudinal ends of the relief valve 220 (and to the filtering medium 210). In some embodiments the seal 295 may be formed of an adhesive material, or a paper end disk with adhesive, or a Klebefolie adhesive disposed in a metal disk or custom molded rubber plug, or sealed directly with an adhesive in the canister dome end, or a combination molded seal/anti-drain back device disposed on the threaded end. The seal 295, however, need not be limited to an adhesive material, and in other embodiments may be formed of a rubber, or any other suitable synthetic polymeric material. The seal 295 prevents fluid from bypassing the openings 222, so that when the seal 295 is installed in the relief valve 220 having open longitudinal ends, fluid may not flow through the longitudinal ends of the relief valve 220.

The arrangement of the seal may vary. For instance in some embodiments, such as the embodiment of FIG. 7, the seal 795 may be disposed near the open end 701a of the canister 701. In such embodiment, the closed end 701b of the canister 701 may be devoid of seal 795, and may instead be coated with an adhesive, such that when the filtering medium 710 and the relief valve 720 are inserted into the canister 701, the adhesive disposed on the closed end 701b of the canister 701 forms a seal between the closed end 701b of the canister 701 and the longitudinal ends of the relief valve 720 and the filtering medium 710. Alternatively, as shown in FIG. 8 the seal 295 may be disposed on both longitudinal ends of the relief valve 220. Moreover, some embodiments may be devoid of any seal 295. For instance, the embodiment of FIG. 9b may be modified such that a wall (not shown) joins each of the attachment portions 925 and the valve body 922. Such embodiment may also retain attachment cavities 925a, so that even if the longitudinal ends of the relief valve 920 are closed, the relief valve 920 may still be inserted into the pleats of the filtering medium.

In any of the foregoing embodiments, the fluid may be oil, and more specifically engine oil that is used as lubricant, or as a cooling agent for an internal combustion engine. Alternatively, the fluid may be water, fuel or air. Moreover, the fluid need not be limited to such applications, and may in fact be any fluid, such that the embodiments of the present invention may be implemented into any fluid-based filtration system, in which the filtering medium is used to remove impurities from the given fluid. Further, any of the foregoing embodiments may further include a center tube that is disposed radially inward of the filtering medium where it may provide structural support to the filtering medium. The center tube may be of any suitable material and may include a plurality of openings, such that the fluid inside the fluid filter has a relatively unobstructed or relatively direct flow path through the openings of the relief valve and through the openings in the center tube to an outlet of the fluid filter.

The foregoing disclosure has been set forth merely to illustrate the invention and is not intended to be limiting. Since modifications of the disclosed embodiments incorporating the spirit and substance of the invention may occur to persons having ordinary skill in the art, the invention should be construed to include everything within the scope of the appended claims and equivalents thereof.

What is claimed is:

1. A fluid filter comprising:
a filtering medium; and
a relief valve including an opening, wherein the relief valve is disposed between opposite longitudinal ends of the filtering medium.

2. The fluid filter of claim 1, wherein a flow axis of fluid that flows through the opening is substantially perpendicular to a flow axis of fluid leaving the fluid filter.

3. The fluid filter of claim 1, wherein the filtering medium has a plurality of pleats.

4. The fluid filter of claim 3, wherein the relief valve couples planar surfaces of two pleats.

5. The fluid filter of claim 4, wherein the opening is directly connected to an outlet of the fluid filter.

6. A relief valve for a filter including a filtering medium, the relief valve comprising:
a body including at least one opening; and
a movable portion that in a first configuration prevents a fluid from flowing through the at least one opening, and in a second configuration allows the fluid to flow through the at least one opening, wherein
the body has an elongated shape having a length that substantially corresponds to a length of the filtering medium along a longitudinal axis of the filtering medium.

7. The relief valve of claim 6, wherein in the first configuration, the movable portion is formed by two surfaces that extend from the body, and the two surfaces abut each other along the length of the body.

8. The relief valve of claim 6, wherein in the first configuration, the movable portion is in direct contact with the at least one opening.

9. The relief valve of claim 7, wherein in the first configuration, a space separates the at least one opening from the two surfaces.

10. The relief valve of claim 9, wherein the two surfaces abut radially exterior to the at least one opening.

11. The relief valve of claim 9, wherein the two surfaces abut radially interior to the at least one opening.

12. The relief valve of claim 6, further comprising:
two attachment portions that couple the relief valve to two pleats of the filtering medium.

13. The relief valve of claim 12, wherein the body, the movable portion, and the two attachment portions are integrally formed.

14. The relief valve of claim 12, wherein each of the two attachment portions contacts at least two different surfaces and an edge of the two pleats.

15. The relief valve of claim 12, further comprising:
means for securing the two attachment portions to the filtering medium.

16. The relief valve of claim 7, wherein a cross-section of the relief valve is substantially m-shaped.

17. The relief valve of claim 8, wherein the at least one opening includes a plurality of openings arranged in two rows, and the two rows are: i) substantially parallel to one another, and ii) substantially coextensive with the length of the body.

18. The relief valve of claim 6, further comprising:
means for directing a flow of the fluid from the relief valve to the filtering medium.

19. The relief valve of claim 6, further comprising:
a flex point that extends along the length of the body, the flex point being formed at a junction between the body and movable portion.

20. An fluid filter comprising:
a canister having a closed end and a lateral wall, wherein one side of the lateral wall is connected to the closed end, and another side of the lateral wall defines an open end of the canister;
a filtering medium disposed inside the canister;
a base plate disposed on the open end of the canister; and
a relief valve that is disposed on the filtering medium and is configured to allow fluid to flow through the relief valve after a pressure inside the fluid filter reaches at least a threshold level, wherein
the relief valve has an elongated body that is substantially parallel to the lateral wall.
